(19) United States
(12) Patent Application Publication
(10) Pub. No.: US 2021/0105973 A1
(43) Pub. Date: Apr. 15, 2021

(54) INDOOR-TYPE CAT NEST CONFORMING TO ECOLOGICAL ENVIRONMENT STANDARDS OF CATS

(71) Applicants: Chin Pao Lin, Shenzhen (CN); SHENZHEN DOGCARE INNOVATION & TECHNOLOGY CO., LTD., Shenzhen (CN)

(72) Inventor: Chin Pao Lin, Shenzhen (CN)

(21) Appl. No.: 16/845,064

(22) Filed: Apr. 9, 2020

(30) Foreign Application Priority Data
Oct. 15, 2019 (CN) 201910979532.7

(51) Int. Cl. A01K 1/035; A01K 1/015; H05B 3/36

(52) U.S. Cl. CPC A01K 1/035; H05B 3/36; A01K 1/0157

(57) ABSTRACT

An indoor-type cat nest conforming to ecological environment standards of cats is provided, relating to the field of a cat nest. The indoor-type cat nest conforming to ecological environment standards of cats includes a cat nest body and a cat sleeping mat. The cat nest body includes an upper cat nest and a lower cat nest detachably connected to the upper cat nest by a connecting means; the cat sleeping mat is removably disposed in the lower cat nest and includes a graphene inner liner removably arranged therein. The cat nest provided by an embodiment of the present application can conform to ecological environment standards of cats and meet their living habits.

### CROSS REFERENCE TO RELATED APPLICATIONS

The present application is based on Chinese patent application No. 201910979532.7 filed on Oct. 15, 2019 and claims its priority. The entire disclosure of the application is hereby incorporated by reference in its entirety.

### TECHNICAL FIELD

The application relates to a cat nest, in particular to an indoor-type cat nest conforming to ecological environment standards of cats.

### BACKGROUND

Cats have been a good partner of humans since ancient times. There are cats everywhere in the world where humans live. Cats like to be alone and free to move. In addition to mating, there rarely live in groups. Cats would not recognize a specific owner by nature, but when a cat is kept in a family for a period of time, its habit can also be changed, and eventually can establish emotional connections with the owner under care, training and taming by the owner. During this process, the cat establishes a concept of regarding the host family and the surroundings as its own territory.

Humans always regard their home as a safe haven, and regard the home as a place where they can express their feelings. More people like to put their privacy at home. No matter what they put in their home, the home is the most trustworthy, the most dependable and safest place to people. Similarly, although cats always seem to be indifferent and arrogant, they are indeed not as independent as they look like. They also rely on their owners and like to stay with them. Also, cats maintain high alertness even during rest or sleep. As soon as the cat hears a slight noise or see something strange, it will immediately open its eyes and stare and be ready to run away at any time. It will leave until it finds no threat at all. In addition, sleeping is an important behavior that cannot be lack of for animals. Sleeping can relieve the fatigue of the body and brain, and can accumulate strength and energy for the next activity. The sleeping time of cats is about twice the sleeping time of humans. But the sleeping time of cats is not continuous as that of humans, instead, it is divided into several times, so cats can get up at any time in the night. It has been studied that three-quarters of a cat's sleep is a fake sleep, that is, a nap. Therefore, it seems that the cat sleeps for 16 hours a day. In fact, the time of deep sleep is only about 4 hours.

Humans have various postures while sleeping, and cats also have various postures when sleeping as humans do. Cats can sleep on their stomach, sleep while sitting and sometimes lie on their back. Cats carefully choose the place of sleeping. In summer, they can find a ventilated and cool place. In winter, they can find a warm place. Furthermore, cats will move their sleeping place according to the movement of the sun, like sunflowers always facing the sun. Therefore, cats always strive to find the most comfortable place to sleep. For example, cats like sleeping near heaters, but this often causes their tails to be burnt; Female cats and kittens sometimes choose a comfortable place to sleep together.

In early time, people always thought that a cat nest was simply made of a cardboard box or old clothes and similar materials, but in a modern city, with the improvement of people's living standards, the pet cats also require more. Cat owners buy a lot of cat supplies such as litter boxes, climbing towers, mats for preventing cat litter from tumbling all over, nail clippers for cat, climbing board, cat bag, cat nest and so on, trying various types of cat supplies to provide the cat with a good living environment like humans. Many cat owners find that trying various types of cat nest cannot please the cats. Think about where your cat likes to sleep. Therefore, it is a key point that a cat nest can make the cat lay down its guard and feel safe and sheltered, and the cat can sleep in this cat nest instead of on the owner's nest.

At present, most cat nests on the market emphasize only the material and comfort, but have not taken the living habits of cats and cats with different personalities into consideration. If an inappropriate cat nest is used, it is easy for the cat to be highly alert for a long time. This is detrimental to the cat and easily makes the cat depressed.

How to choose a suitable and high quality cat nest is not just about its material, comfort and warmth. It also needs to conform to the ecological environment of cats, considering living habits of cats and cats with different personalities, so that the cat feels safe, sheltered, and warm and loves to sleep in the cat nest. For those who are busy with work, it is most convenient to use this type of cat nest conforming to ecological environment standards of cats, since pet owners no longer have to worry about the environment in which cats live.

### SUMMARY

The technical problem to be solved by the embodiments of the present application is how to provide an indoor-type cat nest conforming to ecological environment standards of cats.

In order to solve the above problem, an embodiment of the present application provides an indoor-type cat nest conforming to ecological environment standards of cats, including: a cat nest body and a cat sleeping mat. The cat nest body includes an upper cat nest and a lower cat nest, and the upper cat nest and the lower cat nest are detachably connected by a connecting means; the cat sleeping mat is removably disposed in the lower cat nest, the cat sleeping mat includes a graphene inner liner removably arranged in the cat sleeping mat.

A further technical proposal is that an inner space of the upper cat nest and the lower cat nest is in communication with each other, and the upper cat nest is provided with an entrance and exit opening.

A further technical proposal is that the entrance and exit opening has a circular arc shape.

A further technical proposal is that the connecting means is a zipper.

A further technical proposal is that the cat sleeping mat further includes an outer upper layer of fabric and an outer lower layer of fabric; the outer lower layer of fabric is provided with an opening, and the graphene inner liner is positioned between the outer upper layer of fabric and the outer lower layer of fabric through the opening; the opening is provided with an opening and closing means.

A further technical proposal is that the opening and closing means is a zipper.

A further technical proposal is that the outer lower layer of fabric is a felt fabric.

A further technical proposal is that the outer upper layer of fabric is a crystal super-soft cloth.

A further technical proposal is that the graphene inner liner is in electrical connection with a power supply to supply power to the graphene inner liner; after power is supplied, the graphene inner liner generates a far-infrared light.

A further technical proposal is that the upper cat nest and the lower cat nest are each made by a plurality of base materials, stitch lines are formed between the base materials of the upper cat nest and the lower cat nest, the upper cat nest and the lower cat nest can be folded along their own stitch line.

A further technical proposal is that the indoor-type cat nest conforming to ecological environment standards of cats further includes cat nest supports, the cat nest supports are disposed inside the cat nest body, and two ends of each of the cat nest supports are respectively abutted against the upper cat nest and the lower cat nest.

The embodiment of the present application provides an indoor-type cat nest conforming to the cat ecological environment standards. The upper cat nest and the lower cat nest of the indoor-type cat nest conforming to the cat ecological environment standards can be used separately, and can be folded for storage, they are portable and easy to wash and clean, thus can fully meet the preference of cats for cleanness as their natural instincts, thereby allowing cats to live in a clean, warm, dry, bright and healthy environment.

The structure of the cat nest body is such that the upper cat nest has a circular arc-shaped opening and is combined with the lower cat nest by a zipper, thereby forming a semi-concealed entrance and exit opening. The semi-concealed entrance and exit opening can provide a safe and sheltered space for the cat to lower its guard and meet its natural instincts in aspects of security and privacy so that the cat is fond of sleeping in the cat nest. The design of the structure of the semi-concealed entrance and exit opening can also enable the air circulation in the cat nest. This structural feature not only considers the shelter effect of the cat nest, but also makes the air flow smoothly and prevents the air in the cat nest from becoming dirty and producing odor, which makes the cat feel comfortable.

The graphene inner liner inside the cat sleeping mat can generate far-infrared light after power is supplied. The far-infrared light has a long wavelength, so it has strong penetration, which can send warmth to the inside of the cat's body, warming it up from the inside.

Further, the far-infrared light can activate the constituent cells of animals and increase the metabolism, and the blood circulation will become smoother so that the animal will then become healthier. In the fast-paced life nowadays, for those who are busy with work, it is most convenient to use this indoor-type cat nest that can keep warm and healthy and conform to ecological environment standards of cats.

Further, the far-infrared light generated by the graphene inner liner in the cat sleeping mat after power is supplied is the same as the sunlight, and the bacteria hidden in the dense hair are eliminated by the irradiation of the far-infrared light. It is a safe deworming and antibacterial design. Graphene materials also have an antibacterial effect, it is another potential physical antibiotic that has no resistance, while traditional antibacterial agents such as antibiotics and quaternary ammonium salts not only cause microbial resistance, but also result in serious environmental pollution.

### BRIEF DESCRIPTION OF THE DRAWINGS

In order to more clearly illustrate the technical proposals of the embodiments of the present application, the drawings used in the description of the embodiments will be briefly described below. It is obvious that the drawings in the following description are some embodiments of the present application. For an ordinary person skilled in the art, other drawings can be obtained based on these drawings without any creative work.

FIG. 1 is a perspective view of an indoor-type cat nest conforming to ecological environment standards of cats according to an embodiment of the present application;

FIG. 2 is another perspective view of the indoor-type cat nest conforming to ecological environment standards of cats according to the embodiment of the present application;

FIG. 3 is a schematic view of the structure of an upper cat nest of the indoor-type cat nest conforming to ecological environment standards of cats according to the embodiment of the present application;

FIG. 4 is a schematic view of the structure of a lower cat nest of the indoor-type cat nest conforming to ecological environment standards of cats according to the embodiment of the present application;

FIG. 5 is an exploded view of a cat sleeping mat of the indoor-type cat nest conforming to ecological environment standards of cats according to the embodiment of the present application;

FIG. 6 is a sectional view of the cat sleeping mat of the indoor-type cat nest conforming to ecological environment standards of cats according to the embodiment of the present application;

FIG. 7 is a first schematic view of stitch lines of the indoor-type cat nest conforming to ecological environment standards of cats according to the embodiment of the present application;

FIG. 8 is a second schematic view of stitch lines of the indoor-type cat nest conforming to ecological environment standards of cats according to the embodiment of the present application;

FIG. 9 is a third schematic view of stitch lines of the indoor-type cat nest conforming to ecological environment standards of cats according to the embodiment of the present application;

FIG. 10 is a schematic view of stitch lines of the upper cat nest of the indoor-type cat nest conforming to ecological environment standards of cats according to the embodiment of the present application;

FIG. 11 is a schematic view of stitch lines of the lower cat nest of an indoor-type cat nest conforming to ecological environment standards of cats according to the embodiment of the present application;

FIG. 12 is a schematic view of cat nest supports of the indoor-type cat nest conforming to ecological environment standards of cats according to the embodiment of the present application;

FIG. 13 is another schematic view of the cat nest supports of the indoor-type cat nest conforming to ecological environment standards of cats according to the embodiment of the present application;

FIG. 14 is a schematic view showing positions of the cat nest supports of the indoor-type cat nest conforming to ecological environment standards of cats according to the embodiment of the present application.

### REFERENCE NUMBERS

Cat nest body 1; upper cat nest 11; lower cat nest 12; connecting means 13; entrance and exit opening 14; cat sleeping mat 2; graphene inner liner 21; outer upper layer of fabric 22; outer lower layer of fabric 23; opening 24; opening and closing means 25; base material 3; stitch line 4; cat nest support 5.

### DESCRIPTION OF THE EMBODIMENTS

The technical proposals in the embodiments will be clearly and completely described below with reference to the accompanying drawings of the embodiments of the application. It is apparent that the embodiments to be described below are merely a part of the embodiments of the present application, and not all of them. All other embodiments obtained by those skilled in the art based on the embodiments of the present application without creative efforts are within the scope of the present application.

It should be understood that, when used in this specification and the appended claims, the terms “include” and “comprise” indicate the presence of the described features, integers, steps, operations, elements and/or components, but do not preclude the presence or addition of a plurality of other features, integers, steps, operations, elements, components, and/or collections thereof.

As used in the embodiment of the present application and in the appended claims, the singular forms “a”, “one” and “the” are intended to include the plural forms unless the context clearly indicates otherwise.

The present application provides an indoor-type cat nest conforming to ecological environment standards of cats according to their habit, which mainly includes the following: The first thing cats like most is sleeping. Cats spend an average of 16 hours a day in sleeping. As mentioned above, what is equivalent to sleeping to a cat is to respect its sleeping time. Cat owners can notice that cats do not like to be disturbed when sleeping, just like humans do not like to be disturbed while they are sleeping.

The second thing is that cats like basking in the sun. So why do cats like sunbath? There may be some bugs existing on their bodies, and sun light can kill those bugs. If a cat is fond of having sunbath, then the cat may be very healthy. It is because that calcium compounds formed under the sun light can be taken in to its body, and the sun light can also aid elimination of bacteria hidden in the dense hair, which is beneficial to the cat's body.

The third thing is that cats instinctively love cleanness. Cats like to live in a clean, warm, dry and bright environment. Cats always clean their hair, especially after eating, excretion, or accidentally stepping onto a dirty and wet place. They always use their tongue to lick throughout their bodies. There is also an important physiological function for cats to lick their hair. When a cat licks its hair, it can stimulate the secretion of sebaceous glands, making the hair shiny and smooth and difficult to get wet by water, also it can take in a small amount of vitamin D to promote the normal development of its bones. In addition, after the hair is fluffy, it can also promote heat dissipation.

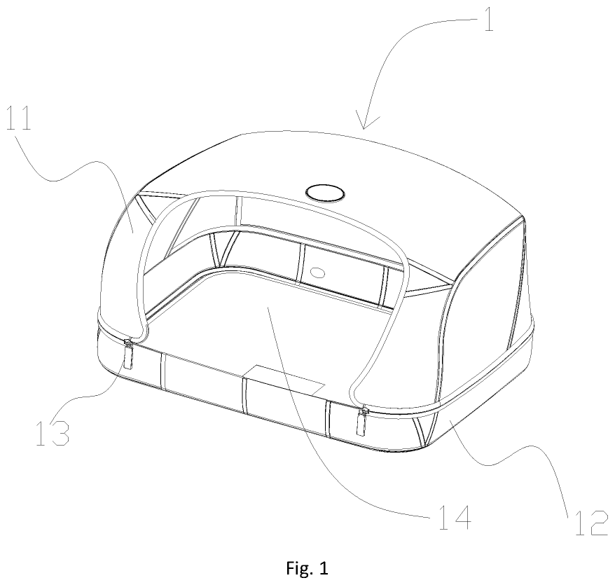

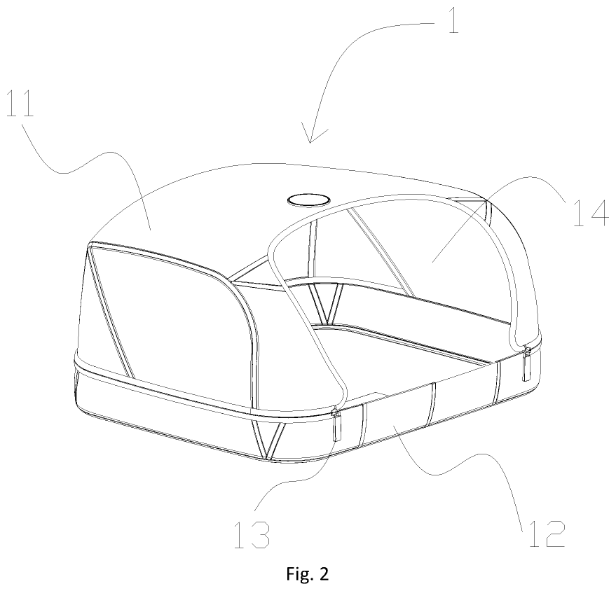

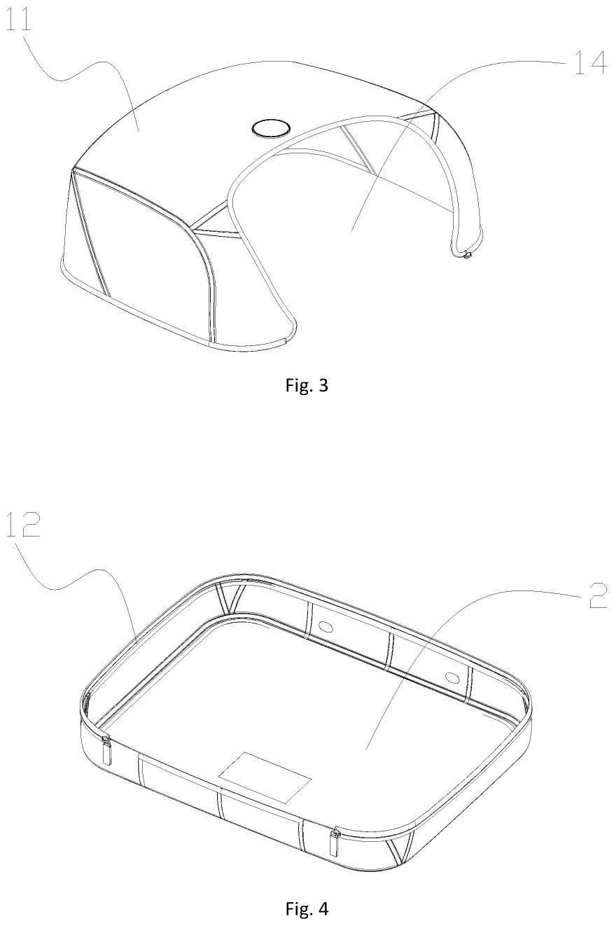

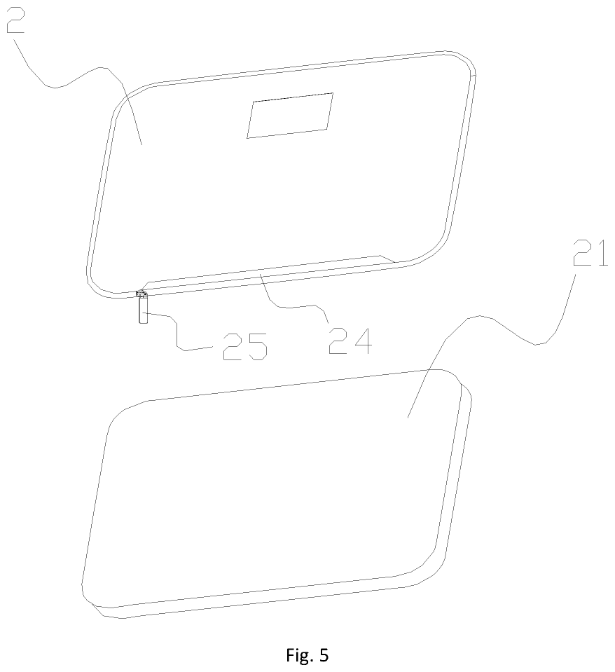

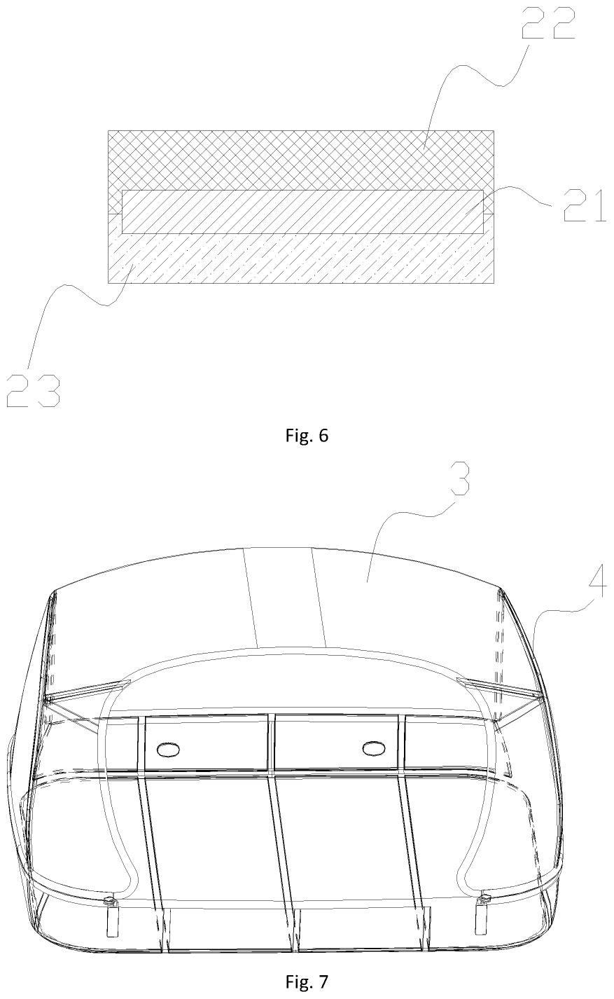

In order to meet the habits of cats, referring to FIG. 1 to FIG. 6, an embodiment of the present application provides an indoor-type cat nest conforming to ecological environment standards of cats, which includes a cat nest body 1 and a cat sleeping mat 2.

The cat nest body 1 includes an upper cat nest 11 and a lower cat nest 12, the upper cat nest 11 and the lower cat nest 12 are detachably connected by a connecting means 13. The cat sleeping mat 2 is removably disposed in the lower cat nest 12. The cat sleeping mat 2 includes a graphene inner liner 21, and the graphene inner liner 21 is removably arranged in the cat sleeping mat 2.

Further, the space in the upper cat nest 11 and the space in the lower cat nest 12 are in communication with each other, the upper cat nest 11 is provided with an entrance and exit opening 14.

Further, the entrance and exit opening 14 has a circular arc shape. It can be understood that the circular arc-shaped opening of the entrance and exit opening of the cat nest provided by the embodiment of the present application features is semi-concealed.

Further, the connecting means 13 is a zipper.

The body of the indoor-type cat nest conforming to ecological environment standards of cats provided by the embodiment of the present application is configured such that the upper cat nest 11 and the lower cat nest 12 are combined and separated by means of a zipper. The upper cat nest 11 and the lower cat nest 12 can be used separately, and the upper cat nest and lower cat nest 12 can be folded and stored. They are portable and easy to wash and clean, thus can fully meet the preference of cats for cleanness as their natural instincts, thereby allowing the cat to live in a clean, warm, dry, bright and healthy environment.

The structure of the cat nest body 1 is such that the upper cat nest 11 has a circular arc-shaped opening and is combined with the lower cat nest 12 by a zipper, thereby forming a semi-concealed entrance and exit opening 14. The semi-concealed entrance and exit opening 14 can provide a safe and sheltered space for the cat to reduce its wariness and meet the natural instincts of the cat in aspects of security and privacy so that the cat is fond of sleeping in the cat nest.

The design of the structure of the semi-concealed entrance and exit opening 14 can also enable the air circulation in the cat nest. This structural feature not only considers the shelter effect of the cat nest, but also makes the air flow smoothly and prevents the air in the cat nest from becoming dirty and producing odor, which makes the cat feel comfortable.

Further, the cat sleeping mat 2 further includes an outer upper layer of fabric 22 and an outer lower layer of fabric 23; the outer lower layer of fabric 23 is provided with an opening 24, and the graphene inner liner 21 is positioned between the outer upper layer of fabric 22 and the outer lower layer of fabric 23 through the opening 24; the opening 24 is provided with an opening and closing means 25. The graphene inner liner 21 can be easily removed or inserted via the opening and closing means 25.

Further, the opening and closing means 25 is a zipper. With the zipper as the opening and closing means, the user can unzip the zipper to insert or remove the graphene inner liner. After the graphene inner liner is removed, the outer fabric can be washed and cleaned. The design of these structural features is that it cannot only fully meet the instinct of cats, but also guarantee a safe operation of the graphene inner liner.

Further, the outer lower layer of fabric 23 is a felt fabric.

Further, the outer upper layer of fabric 22 is a crystal super-soft cloth.

Further, the graphene inner liner 21 is electrically connected to a power supply source, in order to supply power to the graphene inner liner 21 from the power supply source; after the power is supplied to the graphene inner liner 21, the graphene inner liner 21 can produce a far-infrared light.

Further, the supplied voltage of the power supply source is a direct current of 5 V.

The graphene inner liner in the cat sleeping mat is not washable due to the requirement of operating in connection with an external power source. In order to solve this problem, the present application is provided with an outer lower layer of fabric having an opening and a zipper. The graphene inner liner can be inserted or removed once the zipper is unzipped. The outer fabric can be washed and cleaned after removing the graphene inner liner. The features of this design cannot only fully meet the preference of cats for cleanness as their instinct, but also make the graphene inner liner operate safely and provide a mild heating and healthcare function.

After the graphene inner liner is supplied with power, carbon molecules in the graphene generate phonons, ions and electrons in the electrical resistance, and the generated carbon molecules are rubbed and collided (also called Brownian motion) to generate thermal energy. The thermal energy is evenly radiated in a planar manner by controlling the far-infrared light with a wavelength of 5-14 microns. The far-infrared light radiated can shine into the cat's body like the sunlight, making the cat feel warm. This phenomenon is known as light penetration. The degree of light penetration is proportional to the wavelength of light. Light with a shorter wavelength, that is, infrared light (near-infrared light) does not have strong penetrating power like far-infrared light. Ordinary heaters or stoves with infrared light only heat up the surface of the skin but do not penetrate into the core of the body, whereas the far-infrared light has a long wavelength, so it has a strong light penetrating power, which can transmit heat to the inside of the body, so that the body warms up from the inside. Near-infrared light can make the surface of the body heat up, but cannot warm up the inside of the body. Far-infrared light can make animals feel warm without a high temperature to stimulate the body. This makes the far-infrared light become to draw attention. The resonance, penetrating, and warming effects of far-infrared light on cells have been widely used in health industries. Therefore, far-infrared light is a kind of light that is beneficial to animals, and can be said to be the light of life.

Far-infrared light with a wavelength of 5-14 microns generated by the graphene inner liner radiates uniformly in a planar manner. The far-infrared light radiated from the graphene can shine into the cat's body like the sunlight, making the cat feel warm. Furthermore, the graphene inner liner can provide a gentle heating effect, while the far-infrared light can activate the constituent cells of the animal body and increase the metabolism, hence the blood circulation will become smoother, and the animal body will become healthier.

Further, the far-infrared light can activate the constituent cells of animals and increase the metabolism, and the blood circulation will become smoother so that the animal will then become healthier. In the fast-paced life nowadays, for those who are busy with work, it is most convenient to use this indoor-type cat nest that can keep warm and healthy and conform to ecological environment standards of cats.

Further, the far-infrared light generated by the graphene inner liner in the cat sleeping mat after power is supplied is the same as the sunlight, and the bacteria hidden in the dense hair are eliminated by the irradiation of the far-infrared light. It is a safe deworming and antibacterial design. Graphene materials also have an antibacterial effect, it is another potential physical antibiotic that has no resistance, while traditional antibacterial agents such as antibiotics and quaternary ammonium salts not only cause microbial resistance, but also result in serious environmental pollution.

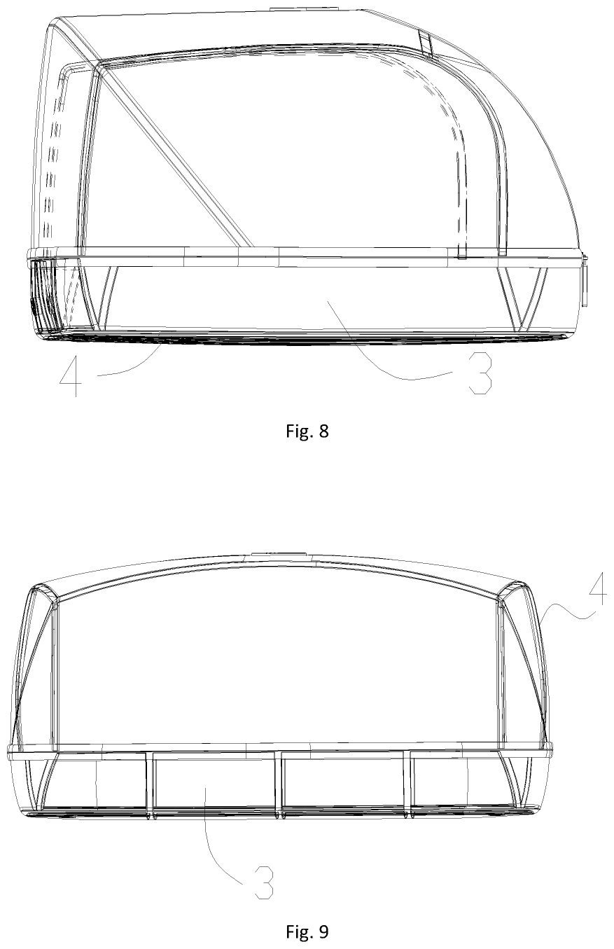

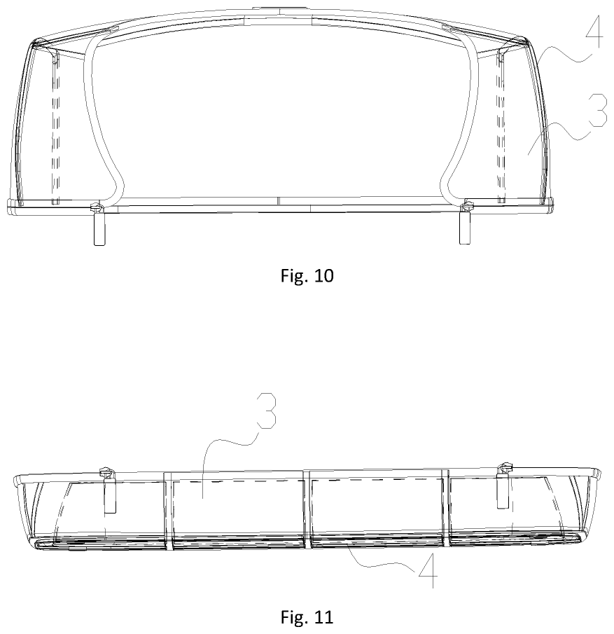

Referring to FIGS. 7-11, in some embodiments, the upper cat nest 11 and the lower cat nest 12 are each made by stitching a plurality of base materials 3 together. Stitch lines 4 are formed between the base materials 3 of the upper cat nest 11 and the lower cat nest 12. The upper cat nest 11 and the lower cat nest 12 can both be folded along their own stitching lines 4. Various shapes of the cat nest cat can be formed by using the stitch lines 4 as a structural frame. At the same time, the stitch lines 4 are used as folding lines, so that the upper cat nest 11 and the lower cat nest 12 can be folded and stored for carrying.

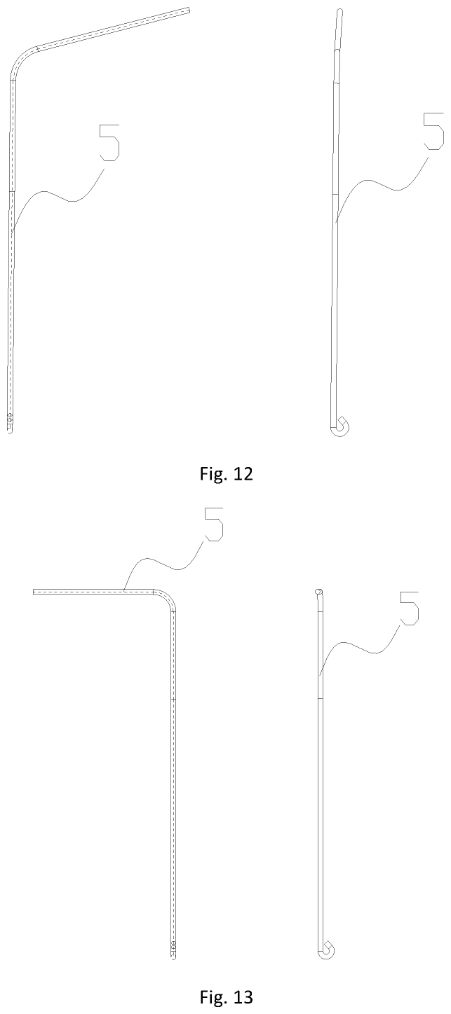

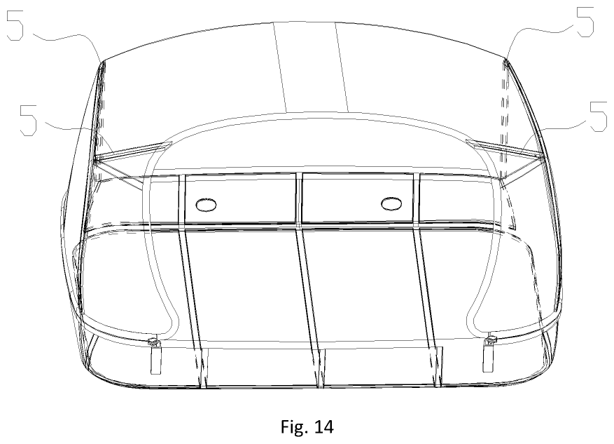

Referring to FIGS. 12-13, the indoor-type cat nest conforming to ecological environment standards of cats further includes cat nest supports 5, which are disposed inside the cat nest body 1. Two ends of each of the cat nest supports 5 are abutted against the upper cat nest 11 and the lower cat nest 12, respectively. The top layer of the cat nest can bear the weight of a cat by using the cat nest supports 5 as structural skeletons of the upper cat nest 11 and the lower cat nest 12. It should be noted that the number of the cat nest supports 5 can be determined according to a specific cat nest structure. For example, referring to FIG. 14, in an embodiment, the number of the cat nest supports is four, and the four cat nest supports are arranged such that two supports are in the front and two supports are in the rear of the cat nest body 1.

In the above embodiments, the descriptions of the various embodiments are different, and the parts that are not described in detail in a certain embodiment can be referred to the related descriptions of other embodiments.

It is apparent that those skilled in the art can make various modifications and variations to the invention without departing from the spirit and scope of the invention. Thus, yet these modifications and variations of the present application fall within the scope of the claims of the application and their equivalent technology, the present application intends to include these modifications and variations.

The above is a specific embodiment of the present application, but the scope of the present application is not limited thereto, and any equivalent modifications can be easily conceived by those skilled in the art within the technical scope disclosed by the present application. These changes or substitutions are intended to be included within the scope of protection of the application. Therefore, the scope of protection of the present application should be determined by the scope of protection of the claims.

1. An indoor-type cat nest conforming to ecological environment standards of cats comprising,
a cat nest body; and
a cat sleeping mat,
wherein the cat nest body comprises an upper cat nest and a lower cat nest detachably connected to the upper cat nest by a connecting means, the cat sleeping mat is removably disposed in the lower cat nest and comprises a graphene inner liner removably arranged therein.

2. The indoor-type cat nest conforming to ecological environment standards of cats of claim 1, wherein an inner space of the upper cat nest and an inner space of the lower cat nest are in communication with each other, the upper cat nest is provided with an entrance and exit opening.

3. The indoor-type cat nest conforming to ecological environment standards of cats of claim 2, wherein the entrance and exit opening has a circular arc shape.

4. The indoor-type cat nest conforming to ecological environment standards of cats of claim 1, wherein the connecting means is a zipper.

5. The indoor-type cat nest conforming to ecological environment standards of cats of claim 1, wherein the cat sleeping mat further comprises an outer upper layer of fabric and an outer lower layer of fabric, the outer lower layer of fabric is provided with an opening, the graphene inner liner is positioned between the outer upper layer of fabric and the outer lower layer of fabric through the opening, the opening is provided with an opening and closing means.

6. The indoor-type cat nest conforming to ecological environment standards of cats of claim 5, wherein the opening and closing means is a zipper.

7. The indoor-type cat nest conforming to ecological environment standards of cats of claim 5, wherein the outer lower layer of fabric is a felt fabric, and the outer upper layer of fabric is a crystal super-soft cloth.

8. The indoor-type cat nest conforming to ecological environment standards of cats of claim 5, wherein the graphene inner liner is in electrical connection with a power supply to supply power to the graphene inner liner, after power is supplied, the graphene inner liner generates a far-infrared light.

9. The indoor-type cat nest conforming to ecological environment standards of cats of claim 1, wherein the upper cat nest and the lower cat nest are each made by stitching a plurality of base materials together, stitch lines are formed between the base materials of the upper cat nest and the lower cat nest, and the upper cat nest and the lower cat nest are foldable along their own stitching lines.

10. The indoor-type cat nest conforming to ecological environment standards of cats of claim 1, wherein the indoor-type cat nest conforming to ecological environment standards of cats further comprises cat nest supports disposed inside the cat nest body, two ends of each of the cat nest supports are respectively abutted against the upper cat nest and the lower cat nest.
